(19) United States
(12) Patent Application Publication
(10) Pub. No.: US 2013/0133203 A1
(43) Pub. Date: May 30, 2013

(54) CUTTING APPARATUS TO CUT A COATING OF A GROOVED TIGHT BUFFERED FIBER

(71) Applicant: Waldemar Stöcklein, Coburg (DE)

(72) Inventor: Waldemar Stöcklein, Coburg (DE)

(21) Appl. No.: 13/669,662

(22) Filed: Nov. 6, 2012

(30) Foreign Application Priority Data
Nov. 30, 2011 (EP) 11191385.1

(51) Int. Cl. G02B 6/245; B26D 7/26

(52) U.S. Cl. 30/90.4; 83/13

(57) ABSTRACT

A cutting apparatus to cut a coating of an optical fiber includes a body having a hole formed therein to insert the fiber and a cutting device to cut the coating of the fiber. When the fiber is inserted in the hole, the cutting apparatus may be disposed around the fiber in a first state and a second state. In the first state, the apparatus is disposed rotatably around a longitudinal axis of the tight buffered fiber. In the second state, rotational movement of the apparatus around the longitudinal axis of fiber is blocked and the apparatus is disposed movably in a longitudinal direction to cut the coating of the fiber by the cutting device.

### PRIORITY APPLICATION

This application claims the benefit of priority under 35 U.S.C. §119 of European Patent Application Serial No. 11191385.1 filed on Nov. 30, 2011 the content of which is relied upon and incorporated herein by reference in its entirety.

### TECHNICAL FIELD

The technology of the disclosure relates to a cutting apparatus to cut a coating of a grooved tight buffered fiber to expose an optical fiber of the tight buffered fiber. The disclosure further relates to a method to cut a coating of a grooved tight buffered fiber to expose the 10 optical fiber of the tight buffered fiber.

### BACKGROUND

Tight buffered fibers are commonly used in different cable designs. This kind of a cable is often preferred, because of its better mechanical protection and its better manageability which is primarily caused by the increased diameter of the up-coated fibers of for example up to 900 μm. A tight buffered fiber may comprise an optical fiber with a typical outside diameter of 250 μm. The optical fiber includes a fiber core and a cladding surrounded by a primary coating. The optical fiber is protected by a secondary coating surrounding the optical fiber, so that the tight buffered fiber may have an outside diameter of up to about 900 μm. The secondary coating may comprise a thermoplastic material, such as PVC (Polyvinylchloride), PA (Polyamide) or highly filled PE (Polyethylene) based compounds, for example FRNC (flame-retardant non-corrosive) compounds.

When tight buffered fibers are deployed, the tight buffered fibers need to be either terminated with fiber optic connectors or spliced to other optical fibers. In both applications the secondary coating has to be removed from the tight buffered fiber on a certain length. Different applications lead to different requirements with respect to the total length of the outer coating to be removed. For terminating a tight buffered fiber with a 30 connector only a piece of approximately 30 mm has to be removed. However, when an optical fiber of a tight buffered fiber has to be spliced to another optical fiber, very often the removal of the secondary coating with a length of up to 150 cm is required.

Because of the strong adhesion of the secondary coating of the tight buffered fiber, the stripability gets more difficult the longer the required strip length is. Unfortunately, the adhesion has to maintain a certain level because otherwise the secondary coating will shrink during temperature-cycling and, because of buckling, will lead to a remarkable attenuation increase.

There is an impetus to provide a cutting apparatus to cut a coating of a grooved tight buffered fiber along a short section of the tight buffered fiber which enables to easily removed the coating along a longer section of the tight buffered fiber simply by hands. Furthermore, a method to cut a coating of a grooved tight buffered fiber along a short section of the cable will be specified which enables to prepare the cable such that the coating along a longer section of the cable can easily peeled off by hands.

### SUMMARY

Embodiments disclosed in the detailed description include a cutting apparatus to cut a coating of a grooved tight buffered fiber and methods to cut a coating of a grooved tight buffered fiber.

An embodiment of a cutting apparatus to cut a coating of a grooved tight buffered cable, the cable having a longitudinal axis, comprises a body comprising a hole to insert the tight buffered fiber and a cutting device to cut the coating of the tight buffered fiber. In the condition, when the cable is inserted in the hole, the cutting apparatus is disposed around the tight buffered fiber in a first state and a second state. The cutting apparatus is configured so that, in the first state of the cutting apparatus, the cutting apparatus is disposed rotatably around a longitudinal axis of the cable. The cutting apparatus is further configured so that, in the second state of the cutting apparatus, the rotational movement of the cutting apparatus around the longitudinal axis of cable is blocked and the cutting apparatus is disposed around the cable movably in a direction parallel to the longitudinal axis of the cable. The cutting device is configured to slide over a surface of the cable in the first state of the cutting apparatus and to engage into a groove of the cable in the second state of the cutting apparatus. The cutting device is configured to cut the coating of the cable in the second state of the cutting apparatus by moving the cutting apparatus to cut the coating in the direction parallel to the longitudinal axis of the cable.

An embodiment of a method to cut a coating of a grooved tight buffered fiber comprises the providing of the cutting apparatus. The tight buffered fiber is inserted into the hole. The cutting apparatus is turned around the longitudinal axis of the grooved tight buffered fiber until the cutting device engages into a groove of the tight buffered fiber. The cutting device is pressed through the opening into the groove of the cable and thereby the coating of the cable is cut in a radial direction of the cable. The cutting apparatus is moved in the longitudinal direction of the cable and the coating is cut along the longitudinal direction of the cable.

A further embodiment of a method to cut a coating of a grooved tight buffered fiber comprises a step of providing the cutting apparatus. The tight buffered fiber is inserted into the hole. The cutting apparatus is turned around the longitudinal axis of the cable, wherein during the turning movement, the sensing device slides along the surface of the tight buffered fiber until the sensing device snaps into the groove of the tight buffered fiber. The cutting device is pressed through the opening into the groove of the tight buffered fiber and thereby the coating of the tight buffered fiber is cut in a radial direction of the cable. The cutting apparatus is moved in the longitudinal direction of the tight buffered fiber and the coating of the tight buffered fiber is cut along the longitudinal direction of the tight buffered fiber.

It is to be understood that both the foregoing general description and the following detailed description present embodiments of the cutting apparatus to cut a coating of a grooved tight buffered fiber and the method to cut a coating of a grooved tight buffered fiber, and are intended to provide an overview or framework for understanding the nature and character of the cutting apparatus and method for cutting the coating of the grooved tight buffered fiber as it is claimed. The accompanying drawings are included to provide a further understanding of the cutting apparatus and the method for cutting the coating of a grooved tight buffered fiber, and are incorporated into and constitute a part of this specification. The drawings illustrate various embodiments of the cutting apparatus and the method for cutting the coating of the grooved tight buffered fiber, and together with the description serve to explain the principals and operation of the cutting apparatus and the method.

### BRIEF DESCRIPTION OF THE DRAWINGS

FIG. 1 shows an embodiment of a tight buffered fiber;

FIG. 2 shows an embodiment of a grooved tight buffered fiber;

FIG. 3 shows an embodiment of a cutting apparatus to cut a coating of a grooved tight buffered fiber;

FIG. 4A shows a cross-section of an embodiment of a cutting apparatus to cut a coating of a grooved tight buffered fiber in a first state;

FIG. 4B shows an embodiment of a cutting apparatus to cut a coating of a grooved tight buffered fiber in a second state;

FIG. 5 shows another embodiment of a cutting apparatus to cut a coating of a grooved tight buffered fiber;

FIG. 6 shows a cross-section of an embodiment of a cutting apparatus to cut a coating of a grooved tight buffered fiber.

### DETAILED DESCRIPTION

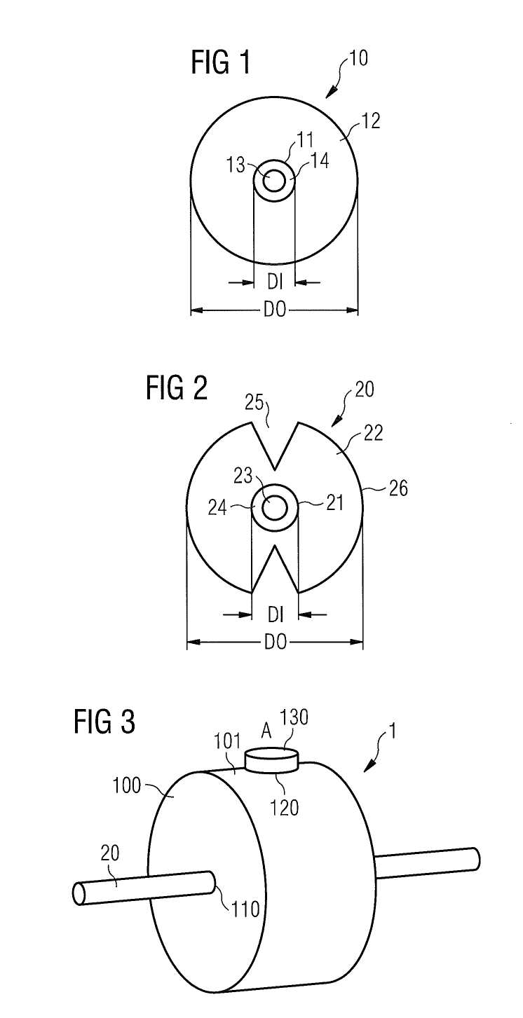

FIG. 1 shows an embodiment of a tight buffered optical fiber 10 comprising an optical fiber 11 and an outer, secondary coating 12 surrounding the optical fiber. The optical fiber may comprise a fiber core and cladding 13 surrounded by a primary coating 14. The optical fiber is protected by the secondary coating 12. The core section 11 may have a diameter DI of 250 μm and the total tight buffered fiber including the outer coating 12 may have an outer diameter DO of about 900 82 m.

If the tight buffered fiber is terminated by a connector or connected to another optical fiber, the outer coating 12 has to be removed from the optical fiber 11. Due to the high adhesion and the small dimensions of the tight buffered fiber, cutting the coating 12 often turns out to be difficult to handle.

FIG. 2 shows an embodiment of a grooved tight buffered fiber 20 comprising an optical fiber 21 which is similarly formed as the optical fiber 11 of the standard tight buffered fiber 10 illustrated in FIG. 1. The core section 21 comprises a fiber core 23 including a cladding which is surrounded by a primary coating 24. The optical fiber 21 is surrounded and protected by a secondary outer coating 22.

In order to weaken the outer coating 22, the coating 22 comprises grooves 25 in the coating 22. The tight buffered fiber may comprise two grooves in the secondary coating 22 which are arranged opposite to each other. Each groove may extend from a surface 26 of the secondary coating in the interior of the coating 22 of the cable to an extent more than half of the diameter of the secondary coating 22.

The grooves may facilitate stripping-off the outer coating 22 from the optical fiber 21. However, due to the small dimensions of the cable which may typically have a diameter DI of the optical fiber 21 of about 250 μm and an outer diameter DO of about 900 μm, it is nevertheless difficult to manually strip-off the coating 22 from the core section 21. The coating may peeled off easily not before the two halves of the secondary coating are separated from each other.

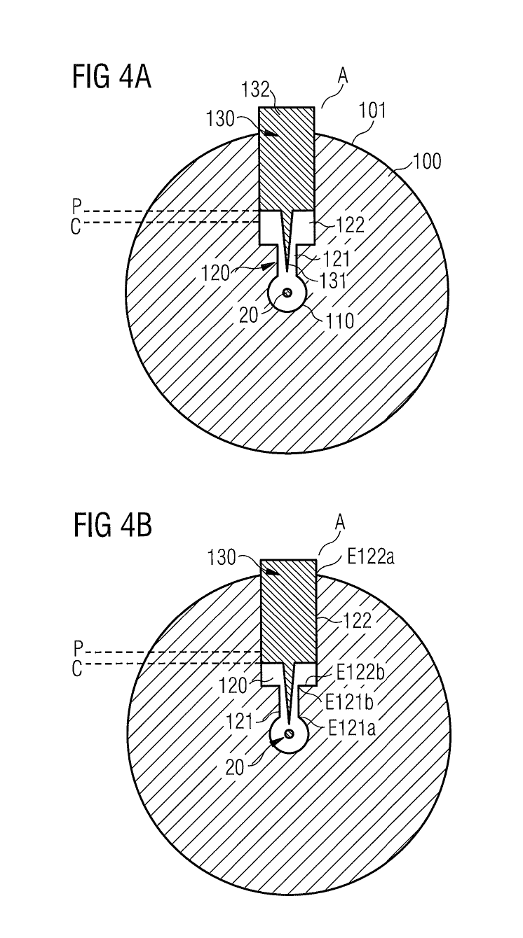

FIG. 3 shows an embodiment of a cutting apparatus 1 to cut a coating 22 of a grooved tight buffered cable 20 in an easy and reliable way. The cutting apparatus 1 comprises a body 100 comprising a hole 110 to insert an optical transmission element, such as a grooved tight buffered fiber 20. The hole 110 may be formed as bore which extends through the center of the body 100. The body 100 comprises an opening 120 placed at a location “A” of the body 100. The opening 120 extends from the outer surface 101 of the body radially into the interior of the body. A cutting device 130 which is configured to cut the secondary coating 22 of the optical cable 20 is provided within the opening 120.

The body 100 of the access tool 1 to expose the optical fiber 21 of the tight buffered fiber may be formed of a rigid material and may comprise a metal or a suitable plastic, for example PBT (Polybutylenetherephthalate), PS (Polystyrole) or PPA (Polhthalamide). The body may have a diameter between 15 mm and 20 mm and a length between 15 mm and 20 mm. The hole 110 may be formed as a bore hole being drilled along a center axis of the body 100 in the material of the body with a diameter between 0.90 mm to 1.0 mm. Other diameters of the hole 110, for example approximately 0.5 mm to 0.7 mm, are also feasible and should be used depending on the nominal diameter of the tight buffered fiber which is intended to be inserted in the bore 110.

FIGS. 4A and 4B show cross sections of an embodiment of the cutting apparatus 1 to cut the secondary coating of a grooved tight buffered fiber 20 at the position “A”. The body 100 of the access tool 1 may be cylindrically shaped and includes the hole 110. The hole 110 may be located in the center of the tool extending through the whole body 100. The hole 110 is formed so that the grooved tight buffered fiber may be inserted into the hole. The body 100 further comprises the opening 120 extending from the outer surface 101 of the body to the hole 110. The cutting device 130 to cut the outer coating 22 of the grooved tight buffered fiber 20 is disposed within the opening 120.

The cutting device 130 may be formed as a stylus comprising a blade 131 and a plunger 132. The plunger 132 is coupled to the blade 131 and projects out of the opening 120. The cutting device is arranged inside the opening 120 movably between a first position, in which the blade 131 is disposed outside the hole 110, and a second position, in which the blade 131 penetrates the hole 110. FIG. 4A shows the first state of the cutting device in which the blade 131 is disposed at a “park” position outside the hole 110. FIG. 4B shows a cross-section of the cutting apparatus 1 at the position “A” with the cutting device 130 being moved to the second position in which the blade 131 extends into the hole 110.

The opening 120 comprises a section 121 and a section 122 being in contact with each other. The section 121 has a narrower diameter than the section 122. The section 121 of the opening 120 has an end E121a coupled to the hole 110 and an end E121b coupled to the section 122 of the opening 120. The section 122 of the opening 120 comprises an end E122a coupled to the surface 101 of the body and an end E122b coupled to the section 121 of the opening 120.

When the tight buffered fiber is inserted in the hole 110, the cutting apparatus 1 may be disposed around the tight buffered fiber in a first state and a second state. In the first state of the cutting apparatus 1, the apparatus 1 is disposed rotatably around a longitudinal axis of the fiber 20, and the blade 131 of the cutting device touches the surface 26 of the grooved tight buffered cable 20. In the second state of the cutting apparatus 1, the cutting device 130 engages into one of the grooves 25 of the grooved tight buffered fiber so that a rotational movement of the cutting apparatus 1 around the longitudinal axis of the fiber 20 is blocked. In the second state of the cutting apparatus 1, the apparatus 1 can only be moved in a longitudinal direction of the cable wherein the blade 131 is guided within the groove 25 of the fiber.

In order to cut the coating 22 of the cable 20, the cable is inserted in the hole 110 up to a length on which the secondary coating 22 has to be removed by the access tool. When the cable 20 is inserted in the opening 110, the cutting device 130 is in a “park” position. In the “park” position the blade 131 is guided within the section 121 of the opening 120 and touches the surface 26 of the outer coating 22 of tight buffered fiber 20.

In order to find one of the grooves 25 for cutting the coating 22 along the groove, the cutting apparatus 1 is turned in the first state around the longitudinal axis of the tight buffered fiber. During the rotational movement of the cutting apparatus 1 the tip of the blade 131 slides over the surface 26 of the outer coating 22 until the blade snaps into one of the grooves 25 of the tight buffered fiber. When the blade 131 engages into the groove 25, the cutting apparatus 1 is in the second state in which a rotational movement of the cutting apparatus is blocked by the blade which is engaged into the groove 25.

Up to now, the cutting device 130 is still projecting out of the opening 120. In order to cut through the secondary coating 22, the cutting device 130 still projecting out of the opening 120 can be pressed in the opening 120 such that the blade 131 cuts the coating 22 of cable 20 in a radial direction of the tight buffered fiber. The plunger 132 is pressed inside the opening 120 until the plunger hits the end E122b of section 122 of the opening 120. The end E 122b is formed as an arrestor which limits the radial movement of the cutting device 130 in the opening 120. The section 122 has a depth in the body 100 such that the blade 131 intrudes into the hole 110 so that the secondary coating 22 is cut-trough, but the optical fiber 21 itself is not damaged by the sharp tip of the blade 131.

In order to slit the secondary coating 22 along the longitudinal direction of the tight buffered fiber, the cutting apparatus 1 is moved in the longitudinal direction of the cable 20 to the end of the cable when the cutting apparatus 1 is in the second state. The sharp tip of blade 131 cuts the coating 22 along the longitudinal direction of the cable 20 so that the secondary coating 22 is peeled-off along one of the grooves up to the end of the cable.

In order to also cut the coating 22 along the opposite groove of the tight buffered fiber 20, the process of inserting the end of the tight buffered fiber into the hole 110, the step of turning the cutting apparatus 1 until the cutting device snaps into the opposite groove, the step of pressing the cutting device 130 into the opening 110 to cut through the coating 22 of the tight buffered fiber in the radial direction, and the step of moving the cutting apparatus 1 in the longitudinal direction of the tight buffered fiber towards the end of the tight buffered fiber to slit the coating 22 at the opposite notch 25 of the tight buffered fiber has to be repeated.

When the secondary coating is cut by the access tool 1 along an end section of the cable, the two separated halves of the coating 22 can be peeled off any length needed by pulling apart the two halves of the coating 22 simply by hand.

Instead of using the same cutting apparatus 1 twice to peel off the coating 22 along the opposite grooves, a first and a second cutting apparatus may be put on the tight buffered fiber. The first cutting apparatus is then used to cut the coating 22 along the first groove and the second cutting apparatus may be used to cut the coating 22 along the opposite second groove.

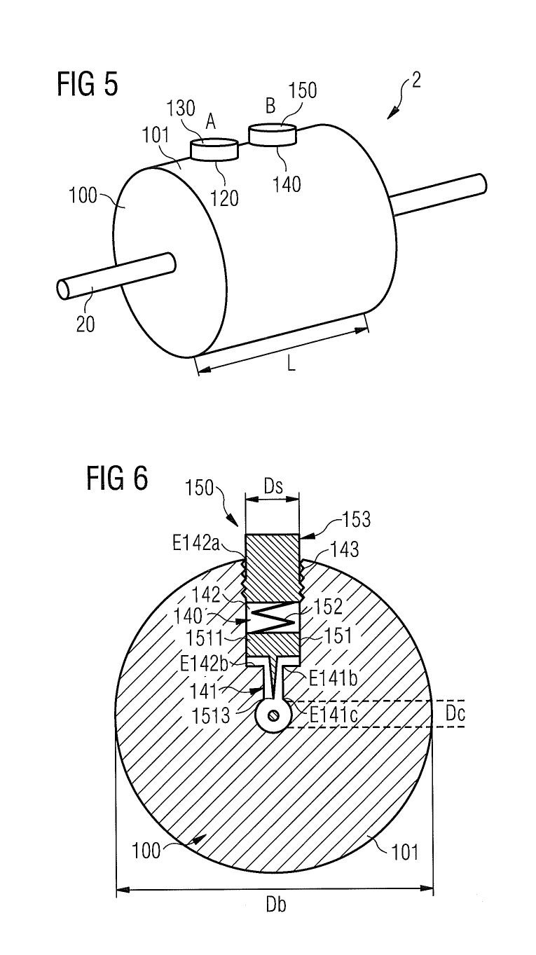

FIG. 5 shows another embodiment of a cutting apparatus 2 to cut the coating 22 of a grooved tight buffered fiber 20. The cutting apparatus 2 comprises a body 100 which may be cylindrical-shaped. The body 100 comprises a hole 110 to insert the cable 20. At a location “A” the body further comprises the opening 120 with the cutting device 130 as explained with reference to FIGS. 4A and 4B. In addition, the body 100 of the access tool 2 is formed with an opening 140 placed at a location “B” of the body 100. The openings 120 and 140 are positioned on a virtual line of the surface 101, the virtual line being parallel to the center axis of the hole 110. The opening 140 extends from the surface 101 of the body 100 into the interior of the body and leads to the hole 110. The cutting apparatus 2 further comprises a sensing device 150 to sense the surface 26 of the cable 20 to find one of the grooves 25 of the cable 20. The sensing device 150 is disposed in the opening 140.

The body 100 of the access tool 2 to expose the optical fiber 21 of the cable may be formed of a rigid material, such as a metal or a suitable plastic, for example PBT (Polybutylenetherephthalate), PS (Polystyrole) or PPA (Pol hthalamide). The body may have a diameter Db between 15 mm and 20 mm and a length L between 15 mm and 20 mm. The hole 110 may be formed as a bore hole being drilled along a center axis of the body 100 in the material of the body with a diameter between 0.90 mm to 1.0 mm. Other diameters of the hole 110, for example approximately 0.5 mm to 0.7 mm, are also feasible and should be used depending on the nominal diameter of the tight buffered fiber which is intended to be inserted in the hole 110.

FIG. 6 shows a cross-section of the body 100 at the position “B”. The opening 140 is formed as a guiding hole for the sensing device 150. The opening 140 comprises a first section 141 and a second section 142 being in contact with each other. The section 141 extends to the hole 110 and the section 142 extends to the surface 101 of the body 100. The section 141 has a narrower diameter than the section 142. Section 142 may have a diameter Ds between 10 mm to 15 mm. The smaller section 141 may have a diameter between 2 mm to 5 mm. An end E141a of section 141 is coupled to the hole 110 and an end E141b of section 141 is coupled to the section 142 of opening 140. An end E142a of section 142 is coupled to the surface 101 of the body 100 and an end E142b is coupled to the section 141 of the opening 140.

The sensing device 150 comprises a stylus 151, a spring element 152 to exert a force on the stylus 151 and an adjusting element 153 to adjust the tension of the spring element. The stylus 150 may comprise a mechanical probe 1511 and a plunger 1512 which are coupled to each other. The mechanical probe 1511 is guided in section 141 of opening 140, and the plunger 1512 is guided in section 142 of opening 140. The mechanical probe 1511 may be formed with a tip 1513 adjusted to slide over the surface 26 of cable 20 and to snap into the groove 25 of the tight buffered fiber 20. The mechanical probe 1512 may be formed with a rounded tip or a ball-shaped head. The round or ball-shaped form of the head 1513 of the mechanical probe facilitates the sliding of the mechanical probe 1512 over the surface 101 of the cable 100 with a low resistance.

In order to adjust the tension of the spring element 152 which presses the stylus 151 towards the surface 26 of the cable 20, the section 142 is formed with a thread 143 extending from the surface 101 in the interior of the opening 140. The adjusting element 153 may be formed as a screw disposed in the thread 143. The tension of the spring element 152 is adjustable by setting the position of the screw 153 in the thread 143.

In order to strip-off the coating 22 of the grooved tight buffered fiber 20, the cable 20 is inserted in the hole 110 of body 100 of the access tool 2. The cutting apparatus 2 may adopt a first state and a second state when the cable 20 is inserted in the hole 110. In the first state of the cutting apparatus 2, the apparatus 2 is disposed rotatably around a longitudinal axis of the cable 20. In the second state of the cutting apparatus 2, the 20 rotational movement of the cutting apparatus 2 around the longitudinal axis of the cable 20 is blocked and the cutting apparatus 2 may just be moved over the cable in a longitudinal direction of the tight buffered fiber.

After inserting the cable 20 into the hole 110, the cutting apparatus 2 to cut the coating 22 is initially in the first state in which the mechanical probe 1511 of the stylus 151 touches the surface 26 of cable 20 without being engaged into one of the grooves 25. The cutting device 130 is in the “park” position so that the blade 132 is disposed in section 121 of the opening 120 and does not extend into the hole 110. In order to find the position of one of the grooves 25, the cable 20 is fixed and the cutting apparatus 2 is turned around the longitudinal axis of the cable 20 so that the head 1513 of the mechanical probe 1511 slides over the surface 26 of cable 20. When one of the grooves 25 of the cable is reached the stylus 150 snaps in the groove. The mechanical probe 1511 engages into the groove 25 of the cable so that a further rotational movement of the cutting apparatus 2 around the longitudinal axis of the cable is blocked by the snapped-in stylus 151.

After having found one of the grooved sections 25 of the cable 20, the cutting device 130 is pressed into the opening 120. Since the openings 120 and 140 are arranged on a virtual line on the the surface 101 of the body being parallel in relation to the hole 110 or optical cable 20, the cutting device 130 penetrates into in the detected groove 25 of the cable to cut the coating 22 of the cable in a radial direction of the cable. The end E122b of the section 122 of the opening 120 is formed as an arrestor which limits the intrusion of the blade 131 into the bore 110 when the cutting device 120 is pressed inside the opening 120. The section 122 is formed with a depth inside the body 100 so that the blade 131 cuts the coating 22 but does not damage the optical fiber 21 of the cable 20.

In order to cut the secondary coating 22, the cutting apparatus 2 is moved in the 15 longitudinal direction of the cable to cut the coating 22 along the longitudinal direction of the tight buffered fiber in one of the grooves 25.

In order to also cut the coating 22 along the opposite groove 25 of the tight buffered fiber, the end of the tight buffered fiber is again inserted into the hole 110 and the steps of turning the cutting apparatus 2 around the cable 20 until the stylus 150 snaps into the opposite groove 25, pressing the cutting device down into the opening 120 to cut the coating 22 in a radial direction, and moving the cutting apparatus 2 towards the end of the tight buffered fiber while pressing the cutting device 130 into the opening 120 to cut the coating 22 along the longitudinal direction of the cable is repeated.

According to another possibility to cut the secondary coating 22 of the grooved tight buffered fiber 20 along both of the grooves a first and a second one of the cutting apparatuses 2 to cut the coating of the tight buffered fiber are provided and are put behind each other on the grooved tight buffered fiber 20. The first cutting apparatus is used to cut the coating 22 along a first one of the grooves, and the second cutting apparatus is used to cut the coating 22 along the opposite second one of the grooves.

After having cut the coating 22 along both of the grooves at an end section of the tight buffered fiber, two halves of the peeled-off coating are accessible so that the two halves can easily further be peeled off manually by any length needed.

When turning the cutting apparatus 1, 2 to cut the coating of the tight buffered fiber to find one of the grooves, the tight buffered fiber has to be fixed in relation to the cutting apparatus 1, 2. A clamping device can be used to clamp the grooved tight buffered fiber when turning the body 100 of the cutting apparatus 1, 2 which facilitates the fixing of the tight buffered fiber. The clamping tool prevents the grooved tight buffered fiber from turning, when the access tool 1, 2 is rotated around the tight buffered fiber to find the position of the grooves.

Although the present cutting apparatus to cut a coating of a grooved tight buffered fiber and the method for cutting the coating of the grooved tight buffered fiber have been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the scope of the present cutting apparatus and the method for cutting the coating of the tight buffered fiber and are intended to be covered by the appended claims. It will also be apparent to those skilled in the art that various modifications and variations can be made to the present cutting apparatus to cut a coating of a grooved tight buffered fiber and the method for cutting a coating of a grooved tight buffered fiber without departing from the scope of the cutting apparatus. Thus, it is intended that the present cutting apparatus and the method cover the modifications and variations of the cutting apparatus to cut the coating of the grooved tight buffered fibers and the method for cutting the coating provided they come within the scope of the appended claims and their equivalents.

What is claimed is:

1. A cutting apparatus to cut a coating of an optical fiber, the fiber having a longitudinal axis, comprising:
a body having a hole formed therein into which to insert the optical fiber; and
a cutting device to cut the coating of the optical fiber,
wherein, when the fiber is inserted in the hole, the cutting apparatus may be disposed around the optical fiber in a first state and a second state,
wherein, in the first state of the cutting apparatus, the cutting apparatus is disposed rotatably around a longitudinal axis of the optical fiber, and the cutting device is configured to slide over a surface of the optical fiber, and
wherein, in the second state of the cutting apparatus, rotational movement of the cutting apparatus around the longitudinal axis of the optical fiber is blocked and the cutting apparatus is disposed movably along the longitudinal axis of the optical fiber.

2. The cutting apparatus of claim 1, wherein the body further includes an opening formed therein extending from an outer surface of the body to the hole, wherein the cutting device is disposed in the opening, and wherein the cutting apparatus further comprises a blade arranged in the opening movably between a first position in which the blade is disposed outside the hole and a second position in which the blade penetrates into the hole.

3. The cutting apparatus of claim 2, wherein the cutting device comprises a plunger coupled to the blade, wherein the plunger projects out of the opening, and wherein the cutting device is configured to be moved from the first position to the second position by pressing the plunger into the opening.

4. The cutting apparatus of claim 3, wherein the opening comprises first and second sections connecting with each other, the first section having a narrower diameter than the second section; and wherein the blade is guided within the first section of the opening and the plunger is guided within the second section of the opening, when the cutting device is moved from the first position to the second position.

5. The cutting apparatus of claim 4, wherein the first section of the opening has a first end leading to the hole and a second end leading to the second section of the opening.

6. The cutting apparatus of claim 5, wherein the second section of the opening comprises a first end leading to the surface of the body and a second end leading to the first section of the opening, and the second end of the second section is formed as an arrestor which limits the intrusion of the blade into the hole, when moving the cutting device from the first position to the second position.

7. The cutting apparatus of claim 4, wherein the second section of the opening comprises a first end leading to the surface of the body and a second end leading to first section of the opening, and the second end of the second section is formed as an arrestor which limits the intrusion of the blade into the hole, when moving the cutting device from the first position to the second position.

8. The cutting apparatus of claim 7, wherein the opening and the cutting device are formed such that, when the fiber is inserted in the hole, the blade of the cutting apparatus cuts a coating of the fiber in a radial direction of the fiber, when the plunger hits the arrestor.

9. A cutting apparatus to cut a coating of an optical fiber, the fiber having a longitudinal axis, comprising:
a body having a hole formed therein into which to insert the optical fiber; and
a cutting device to cut the coating of the optical fiber,
wherein the optical fiber is a tight-buffered optical fiber and the coating is at least a portion of the tight-buffer, wherein the cutting device is configured to engage into a groove of the tight buffered optical fiber and to cut the coating of the tight buffered optical fiber by moving the cutting apparatus along the longitudinal axis of the tight buffered optical fiber,
a sensing device to sense a surface of the tight buffered optical fiber to find the groove of the tight buffered optical fiber;
wherein the body includes another opening formed therein extending from the outer surface of the body to the hole, and the sensing device is disposed in the other opening, and
wherein, when the tight buffered optical fiber is inserted in the hole, the cutting apparatus is disposed around the tight buffered optical fiber.

10. The cutting apparatus of claim 9, wherein the sensing device comprises a stylus, and is formed so that the stylus touches the surface of the tight buffered optical fiber.

11. The cutting apparatus of claim 10, wherein the sensing device comprises a spring element to exert a force on the stylus and an adjusting element to adjust a tension of the spring element, and wherein the spring element is arranged between the stylus and the adjusting element.

12. The cutting apparatus of claim 11, wherein the other opening comprises first and second sections connecting to each other, the first section extending to the hole and the second section extending to the surface of the body, the first section having a narrower diameter than the second section, and wherein the stylus comprises a mechanical probe and a plunger coupled to each other, the mechanical probe being guided by the body via the first section and the plunger being guided by the body via the second section of the other opening.

13. The cutting apparatus of claim 9, wherein the other opening comprises first and second sections connecting to each other, the first section extending to the hole and the second section extending to the surface of the body, the first section having a narrower diameter than the second section, and wherein the stylus comprises a mechanical probe and a plunger coupled to each other, the mechanical probe being guided by the body via the first section and the plunger being guided by the body via the second section of the other opening.

14. The cutting apparatus of claim 13, wherein threading is formed in the body in the second section of the other opening, wherein the adjusting element is a screw disposed in the threading, and wherein tension of the spring element is adjustable by setting the position of the screw in the threading.

15. The cutting apparatus of claim 14, wherein the mechanical probe comprises a round-shaped tip.

16. A method to cut a coating of an optical fiber, comprising:
providing a cutting apparatus to cut the coating of the optical fiber;
inserting the optical fiber into a hole formed in the cutting apparatus,
turning the cutting apparatus around the longitudinal axis of the optical fiber until a cutting device of the cutting apparatus engages a groove of the optical fiber,
pressing the cutting device through an opening formed in the cutting apparatus into the groove of the optical fiber and thereby cutting the coating of the optical fiber in a radial direction of the optical fiber,
moving the cutting apparatus in the longitudinal direction of the optical fiber, and cutting the coating along the longitudinal direction of the optical fiber.

17. The method of claim 16, wherein, during the turning movement, the method further comprises sliding a sensing device along a surface of the optical fiber until the sensing device interfaces the groove of the optical fiber.

18. The method of claim 16, wherein the cutting device comprises a plunger coupled to a blade, the plunger projecting out of the opening, and wherein the cutting device is configured to be moved from the first position to the second position by pressing the plunger into the opening.

19. The method of claim 18, wherein the opening includes first and second sections in communication with each other, the first section having a narrower diameter than the second section, and wherein the blade is guided within the first section of the opening and the plunger is guided within the second section of the opening, when the cutting device is moved from the first position to the second position.

20. The method of claim 19, wherein the first section of the opening has a first end in communication with the hole and a second end in communication with the second section of the opening.
